(19) United States
(12) Patent Application Publication
(10) Pub. No.: US 2021/0330024 A1
(43) Pub. Date: Oct. 28, 2021

(54) ORTHOTROPIC SOLE INSERT AND FOOTWEAR MADE THEREFROM

(71) Applicant: J & P COATS LIMITED, Glasgow (GB)

(72) Inventors: Probir Kumar Guha, Glasgow (GB); John Ilkka, Glasgow (GB)

(73) Assignee: J & P COATS LIMITED, Glasgow (GB)

(21) Appl. No.: 17/237,333

(22) Filed: Apr. 22, 2021

Related U.S. Application Data
(60) Provisional application No. 63/013,653, filed on Apr. 22, 2020.

(51) Int. Cl. A43B 13/02; A43B 13/04; A43B 13/28

(52) U.S. Cl. CPC A43B 13/023; B32B 5/073; A43B 13/28; A43B 13/04

(57) ABSTRACT

A fiber preform includes a substrate. A fiber bundle includes reinforcing fibers arranged on the substrate in a shape of a shoe sole and attached to the substrate by a plurality of stitches of the thermoplastic thread to form a first preform layer having a principal orientation. An orthotropic composite material shoe sole is also provided that includes the fiber preform with a cured molded resin surrounding the fiber preform, the cured molded resin having a shape of the shoe sole. A method of forming a fiber preform for use in a composite material shoe sole is also provided.

### RELATED APPLICATIONS

This application claims priority benefit of U.S. Provisional Application Ser. No. 63/013,653 filed 22 Apr. 2020; the contents of which are hereby incorporated by reference.

### FIELD OF THE INVENTION

The present invention generally relates to shoes and, more particularly, to a new and improved shoe sole construction formed of a three-dimensional fiber preform based composite material.

### BACKGROUND

Many shoe sole constructions have been advanced which attempt to provide maximum comfort and stability for the foot. Other constructions aim at achieving maximum flexibility of the sole. Still other shoe sole constructions attempt to provide as lightweight a shoe as possible while achieving maximum foot stability, shock absorption, and outsole wear.

A problem with existing footwear in general has been that the requirements of comfort, stability, support, flexibility, lightweightness, and durability are difficult to achieve in a single sole construction. Frequently, one of the preceding goals may be achieved in a particular sole design at the expense of another. For example, it is known that to provide durable outsoles, the latter should be made of a relatively dense, durable material which, it may be appreciated, limits its flexibility and foot-cushioning ability and increases the weight of the shoe. Similarly, providing a flexible sole tends to enhance comfort but hamper stability and durability.

Composite materials are increasingly used in several industries because of the ability to balance material properties. For example, Tailored Fiber Placement (TFP) is a textile manufacturing technique in which fibrous material is arranged on another piece of base material and is fixed with an upper and lower stitching thread on the base material. The fiber material can be placed in curvilinear patterns of a multitude of shapes upon the base material. Layers of the fiber material may be built up to produce a three-dimensional fiber preform insert, which may be used as an insert overmolding or resin transfer process to create composite materials. These preforms can then be placed inrResin transfer molding or overmolding (hereafter referred to synonymously as “RTM”), which is a process in which the fiber preform in placed in a mold where a melt processible material is molded directly into the insert. Melt processible materials typically used in overmolding include elastomers and thermoplastics. The major overmolding processes includes insert molding and two-shot molding. Materials are usually chosen specifically to bond together, using the heat from the injection of the second material to form that bond that avoids the use of adhesives or assembly of the completed part, and results in a robust composite material part with a high-quality finish.

Unfortunately, such preform inserts have been unfavorable in terms of production cost, increased scrappage, and diminished throughput, particularly in the footwear industry and thus, the ability to balance the desirably features of footwear discussed above has not yet been realized.

Thus, there exists a need for a footwear sole that balances the desirable features of comfort, stability, support, flexibility, lightweightness, and durability in a single construction.

### SUMMARY OF THE INVENTION

A fiber preform includes a substrate. A fiber bundle includes reinforcing fibers arranged on the substrate in a shape of a shoe sole and attached to the substrate by a plurality of stitches of the thermoplastic thread to form a first preform layer having a principal orientation. An orthotropic composite material shoe sole is also provided that includes the fiber preform with a cured molded resin surrounding the fiber preform, the cured molded resin having a shape of the shoe sole.

A method of forming a fiber preform for use in a composite material shoe sole includes providing a substrate. A first layer of a fiber bundle is applied to the substrate in a predetermined pattern having a principal orientation, the fiber bundle includes reinforcing fibers. The first layer of the fiber bundle is stitched to the substrate using a thread. At least one subsequent layer of the fiber bundle is built upon the first layer. Each of the subsequent layers is stitched to a preceding layer using the thread.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1A is a top view of a fiber bundle stitched to a substrate forming a fiber preform according to one embodiment of the present invention;

FIG. 1B is a top view of a first fiber bundle stitched to a substrate in the shape of a sole insert;

FIG. 1C is a top view of a second fiber bundle stitched to a substrate of FIG. 1B to create strength in varied directions;

FIG. 2 is a cross-sectional top view of the fiber bundle of FIG. 1A;

FIG. 3 is an exploded perspective view a multi-layered fiber preform according to one embodiment of the present invention;

FIG. 4A is a perspective view of the multi-layered fiber preform of FIG. 3;

FIG. 4B is a top view of the perform shaped into an inventive othrotropic sole insert;

FIG. 5 is a top view of a first preform layer of an inventive othrotropic sole insert;

FIG. 6 is a top view of the inventive othrotropic sole insert electronics including the first layer to FIG. 5 with a successive layer retaining electronics and reinforcing elements.

FIG. 7A is bottom view of a cured molded resin shoe sole with bottom side tread 42 formed with an inventive othrotropic sole insert;

FIG. 7B is top view of a cured molded resin shoe sole of FIG. 7A; and

FIG. 8 is a schematic view of a method of forming a shoe sole from an inventive othrotropic sole insert.

### DETAILED DESCRIPTION OF THE INVENTION

The present invention has utility as a fiber preform for use in a composite material shoe sole, an orthotropic composite material shoe sole, and methods of making the same that provide a footwear sole that synergistically balances the desirable features of comfort, stability, support, flexibility, lightweightness, and durability in a single construction.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

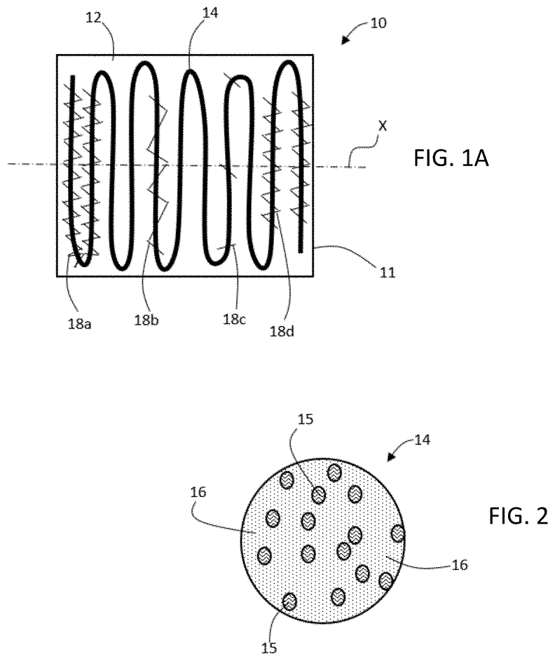

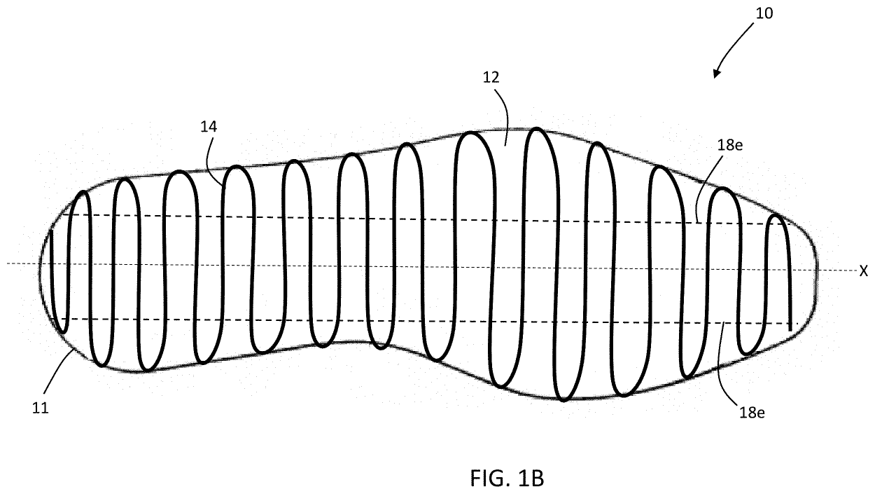

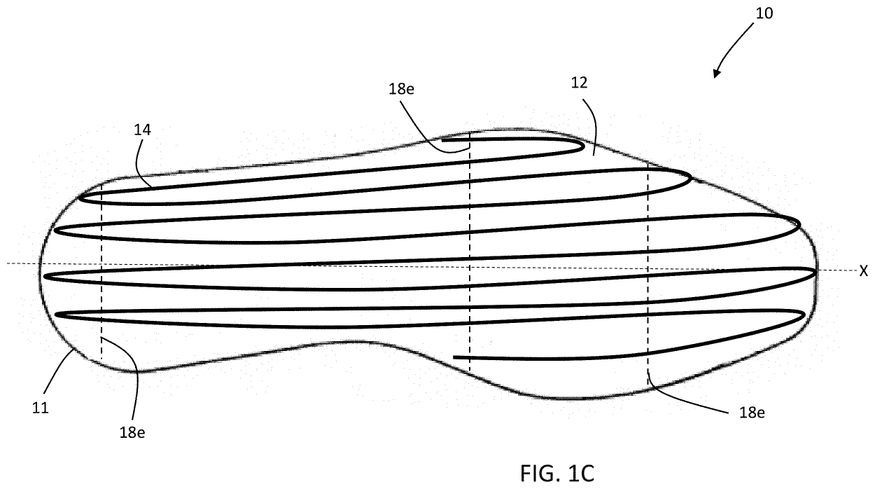

Referring now to the figures, a fiber preform 10 according to embodiments of the present invention is shown. The fiber preform 10 includes a substrate 12 which acts as a foundation or base upon with a fiber bundle 14 is applied. The substrate 12 may be a tear-off fabric or paper or other suitable material. The fiber bundle 14 is applied to the substrate 12 by a selective comingled fiber bundle positioning (SCFBP) method and attached to the substrate 12 by a plurality of stitches 18 of a thread. The fiber bundle 14 may be applied in any arrangement on the substrate 12. The arrangement of the fiber bundle 14 on the substrate 12 may generally resemble the shape of the designed final composite material component, for example a shoe sole. The substrate material 12 may be a large generally rectangular shaped piece of material to which the fiber bundle 14 is applied, such as shown in FIGS. 1A, 3, and 4A, which is subsequently cut into generally shoe sole shaped preforms such as those shown in FIGS. 1B, 1C, 4B, 5, and 6, or the substrate 12 can be pre-cut such that the fiber bundle 14 is applied to a substrate 12 that is already in the shoe sole shape of the resulting preform such as those shown in FIGS. 1B, 1C, 4B, 5, and 6.

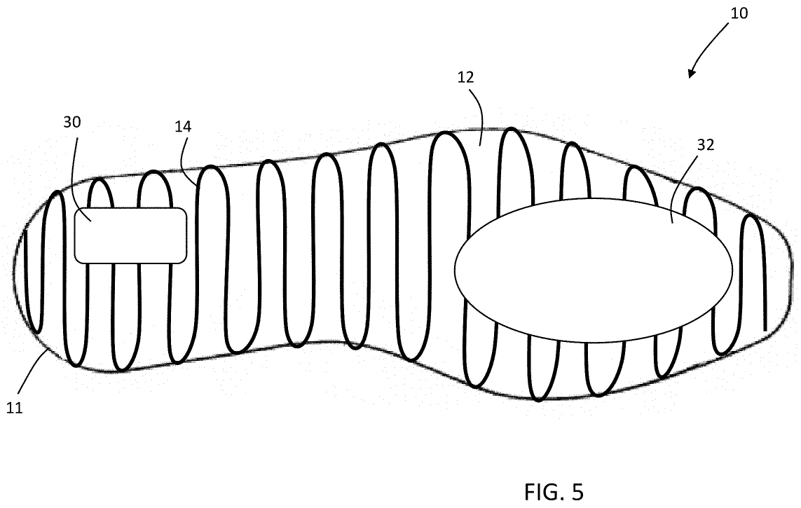

A first layer of the fiber bundle 14 may be arranged in a principal direction, e.g. a walking direction of stress of the final composite material shoe sole. In FIG. 1A, the principal orientation of the fiber bundle 14 is along a longitudinal axis X of the fiber preform 10, however, other suitable orientations are also possible and may be used based on the design considerations and stresses for each composite material part. FIGS. 1A and 5 illustrate only a first preform layer 11.

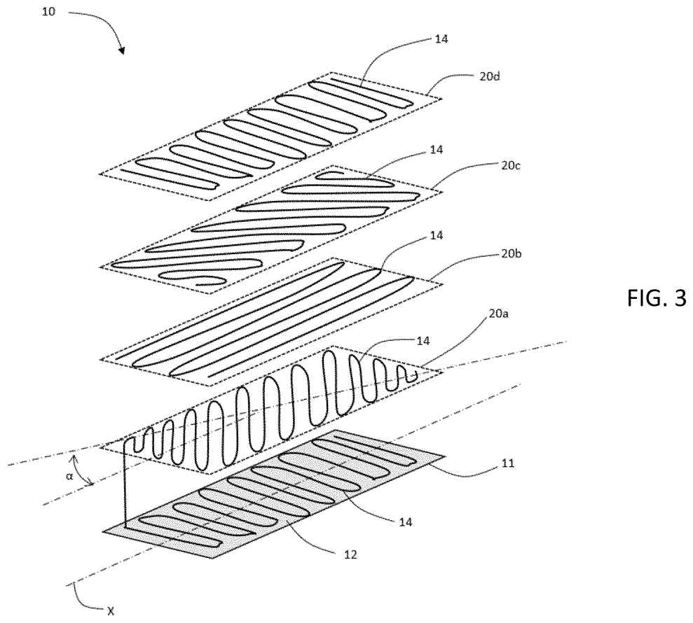

As shown in FIG. 2, the fiber bundle 14 may include a subset of comingled fiber bundle fibers 15, a subset of roving fibers 16, or a combination thereof. The comingled fiber bundle fibers 15 are helical or spun while the roving fibers are parallel to one another and not helical. The fiber bundle 14 is made of comingled reinforcing fibers, such as those made of carbon, glass, Basalt, aramid, or a combination thereof. It is appreciated that the comingled fibers are either parallel to define a roving or include at some fibers that are helically twisted to define a yarn. It is appreciated that the physical properties of reinforcing fibers retained in a helical configuration within a fixed matrix of a completed composite material shoe sole component are different than those of a linear configuration, especially along the reinforcing fiber axis. The relative number of reinforcing fibers relative to any other fibers in the fiber bundle 14 is highly variable in the present invention in view of the disparate diameters of glass fibers, polyaramid fibers, and carbon fibers. The thermoplastic fibers are appreciated to be recycled, virgin, or a blend thereof. The reinforcing fibers of the fiber bundle are present in an amount of 10 to 100 weight percent of the fiber bundle in the present invention.

The fiber bundle 14 may be a single continuous fiber bundle fed from a spool in the SCFBP process to form the fiber preform 10. Alternatively, the fiber preform 10 may be formed of multiple separate fiber bundles. Using multiple fiber bundles to form the fiber preform allows for fiber bundles having different compositions of fibers such as a fiber bundle of entirely reinforcing fibers or a fiber bundle of both reinforcing a thermoplastic fibers, which enables tuning of the fiber preform insert. Additionally, increasing the number of fiber bundles used in the SCFBP process speeds the fiber preform manufacturing process, which increases throughput and efficiency. The multiple fiber bundles may be applied to the substrate together starting from the same end of the substrate or they may be applied spaced apart with each beginning at opposite ends of the substrate and converging at a middle region between the ends of the substrate.

According to embodiments, the fiber bundle also includes thermoplastic fibers which serve to provide a matrix in a composite material made of both reinforcing and matrix fibers. These matrix fibers, when present, being of a thermofusible nature may be formed from a thermoplastic material such as, for example, urethane, nylon, polyethylene terephthalate (PET), epoxy, polypropylenes, polyamides, polyesters, polyether ether ketones, polybenzobisoxazoles, polyphenylene sulfide; block copolymers containing at least of one of the aforementioned constituting at least 40 percent by weight of the copolymer; and blends thereof. The thermoplastic fibers are appreciated to be recycled, virgin, or a blend thereof. The thermofusible thermoplastic matrix fibers have a first melting temperature at which point the solid thermoplastic material melts to a liquid state. The reinforcing fibers may also be of a material that is thermofusible provided their thermofusion occurs at a temperature which is higher than the first melting temperature of the matrix fibers so that, when both fibers are used to create composite, at the first melting temperature at which thermofusibility of the matrix fibers occurs, the state of the reinforcing fibers is unaffected.

As used herein, any reference to weight percent or by extension molecular weight of a polymer is based on weight average molecular weight.

As used herein, the term melting as used with respect to thermoplastic fibers or thread is intended to encompass both thermofusion of fibers such that a vestigial core structure of separate fibers is retained, as well as a complete melting of the fibers to obtain a homogenous thermoplastic matrix.

The thread that attaches the fiber bundle 14 to the substrate 12 may be any suitable thread material such as glass fiber, carbon fiber, aramid fiber, or a thermoplastic thread such as nylon or polyethylene material. The identity of the thermoplastic thread, when present, is selected to have a melting temperature that is lower than the melting temperature of any thermoplastic fibers of the fiber bundle 14. At this lower second melting temperature, the solid thermoplastic thread melts to a liquid state. At this lower melting temperature, thermofusibility of only the thermoplastic thread occurs, while the state of any thermoplastic fibers of the fiber bundle is unaffected. According to various embodiments of the present invention, the melting temperature differential between the melting temperature of the thermoplastic fiber of the fiber bundle (first melting temperature) and the melting temperature of the thermoplastic thread (second melting temperature) may be at least 50° C., while in other embodiments the melting temperature differential may be more than 100° C.

The fiber preform 10 is tunable and easily changed and adapted for varying design requirements. The properties and characteristics of the fiber preform may be changed and modified based on controlling parameters of the various components of the fiber preform including parameters of the fiber bundle 14, the thread, and the plurality of stitches 18. Parameters of the fiber bundle may include, but are not limited to, a diameter of the fiber bundle, a percentage of reinforcing fibers present, and a composition of the reinforcing fibers. Parameters of the thread may include, but are not limited to, a denier of the thread and a composition of the thread. The parameters of the plurality of stitches 18 may include, but are not limited to, a linear distance between the stitches and a tension of the stitches.

Referring again to FIG. 1A, the plurality of stitches 18 are shown in various zig-zag stitch arrangements. For example, the stitches may be closely spaced stitches 18a and 18d or spaced apart by a greater linear distance such as stitches 18b and 18c. The stitches may be continuously connected along the fiber bundle 14 such as stitches 18a, or the stitches may be discrete and separate single stitches 18c or separate groups of stitches such as stitches 18b and 18d. The plurality of stitches of thread may also attach the fiber bundle to itself. Increasing the number of stitches used to attach the fiber bundle to the substrate increases the thread to fiber bundle ratio, which is yet another tunable parameter of the fiber preform. The tension of the plurality of stitches may also be controlled. For example, low tension stitches results in a lose attachment of the fiber bundle to the substrate and more thread material in the fiber preform. Alternatively, high tension stitches result in a tight attachment between the fiber bundle and the substrate, an ability to put the fiber bundle in compression, and less thread material in the fiber preform. The thread to fiber bundle ratio may be controlled according to design configurations by balancing the number, arrangement of, linear distance between, and tension of the plurality of stitches. As shown in FIGS. 1B and 1C the plurality of stitches 18e may be applied to the fiber bundle 14 in a linear pattern that is perpendicular to the arrangement of the fiber bundle 14. Such stitching results in faster and easier application of the stitches 18e.

Referring now to FIG. 3, the fiber preform 10 according to one embodiment of the present invention includes the first preform layer 11 with its principal orientation along the X axis and a plurality of subsequent preform layers 20a, 20b, 20c, 20d formed of the fiber bundle 14 successively stacked from the first preform layer 11. Each subsequent preform layer 20a, 20b, 20c, 20d is arranged on a preceding preform layer and attached to the preceding preform layer by additional stitches of the thread. For example, the first subsequent preform layer 20a is arranged on and attached to the preceding first preform layer 11, the second subsequent preform layer 20b is arranged on and attached to the preceding first subsequent preform layer 20a, the third subsequent preform layer 20c is arranged on and attached to the preceding second subsequent preform layer 20b, and the fourth subsequent preform layer 20d is arranged on and attached to the third subsequent preform layer 20c. While the example fiber preform 10 shown in FIG. 3 includes four subsequent preform layers for a total of five preform layers including the first preform layer, it is appreciated that the plurality of subsequent preform layers may include at least one to twenty layers. The fiber bundle 14 that forms each of the subsequent preform layers may be a continuation of the fiber bundle of the preceding preform layer or it could be a separate piece of fiber bundle.

In FIGS. 3-6, the plurality of stitches of thread are not shown for the sake of clarity, but it will be readily understood that each layer of fiber bundle 14 is attached to the preceding layer and/or to itself by a plurality of stitches identical to those explained throughout the present disclosure. It is appreciated that the stitches used to secure each subsequent preform layer could extend to the substrate, for example if it is desired to have a higher concentration of thread present in the fiber preform. Alternatively, the stitches used to attach each subsequent preform layer can extend to only the preceding preform layer, which allows for a more efficient preform manufacturing process in that the penetration depth of the stitching needle need not be altered between the various layers of fiber bundle. After at least one of the subsequent preform layers has been stacked and attached to the first preform layer, the substrate may be removed from the fiber preform. Alternatively, the substrate may remain attached to the first preform layer until all of the subsequent preform layers have been stacked on and attached to the preceding preform layer, or the substrate can remain attached to the fiber preform throughout the composite material manufacturing process.

As shown in FIG. 3, the orientation of each subsequent preform layer may be offset from the orientation of the preceding preform layer. Offsetting the orientation of the various layers enables strength in multiple directions. The orientation of each subsequent preform layer may be offset from that of the preceding preform layer by an angular displacement a relative to the principal orientation of the first layer, for example the X axis. The layers can be overlaid with a variety of angular displacements relative to a first layer. If zero degrees is defined as the long axis X of the first preform layer 11, the subsequent preform layers are overlaid at angles of 0-90°. For example, in the fiber preform 10 shown in FIG. 3, the angular displacement a is 45° resulting in a 0-45-90-45-0 pattern of preform layers. Further specific patterns illustratively include 0-45-90-45-0, 0-45-60-60-45-0, 0-0-45-60-45-0-0, 0-15-30-45-60-45-30-15-0, and 0-90-45-45-60-60-45-45-90-0. While these exemplary patterns are for from 5 to 10 layers of uni-directional fibers, it is appreciated that the fiber preform may include from 2 to 20 layers. It is appreciated that the preform layers may be symmetrical about a central layer, in the case of an odd number of layers, or about a central latitudinal tope parallel to the players. That is, as shown in FIG. 3, the orientation of the first layer 11 and the last of the subsequent preform layers 20d are generally the same while the first subsequent layer 20a and third subsequent preform layer 20c are symmetrical with one another, such that the layers 11, 20a, 20c, and 20d are symmetrical about the center layer 20b. Providing the various preform layers with symmetrical orientations enables the fiber preform 10 to resist warping.

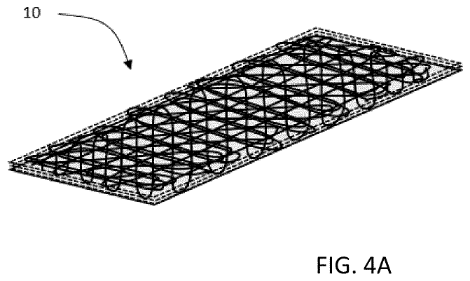

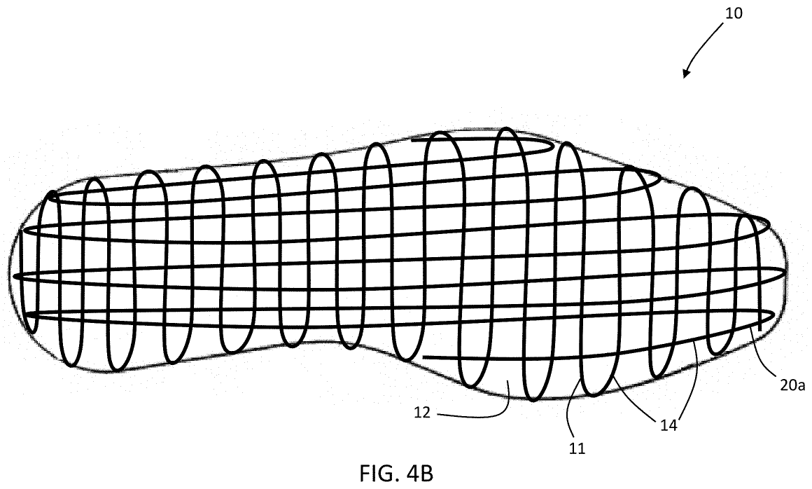

As shown in FIGS. 4A and 4B, a fiber preform 10 having at least one subsequent layer of fiber bundle 14 attached to the first preform layer has fibers that run in offset orientations, which enables strength in multiple directions. For example, the fiber preform 10 shown in FIG. 4B includes a first layer 11 that runs in a predominate direction of 0° from the X axis. This layer provides increased flexibility in the walking direction, i.e. toe to heel direction of the shoe sole. In the second layer, i.e. the at least one subsequent layer 20a the fiber bundle 14 runs in a predominate direction of 90° from the X axis, or perpendicular to the fiber bundle of the first layer. This second layer provides stiffness in the left to right direction of the shoe sole. Thus, the combination of the first fiber bundle layer having an orientation of 0° from the X axis and the second fiber bundle layer having an orientation of 90° from the X axis results in a balance of the desirable features of comfort, stability, support, flexibility, lightweightness, and durability in a single shoe sole construction. The offset layers of fiber bundle additionally result in a shoe sole construction that has excellent puncture resistance.

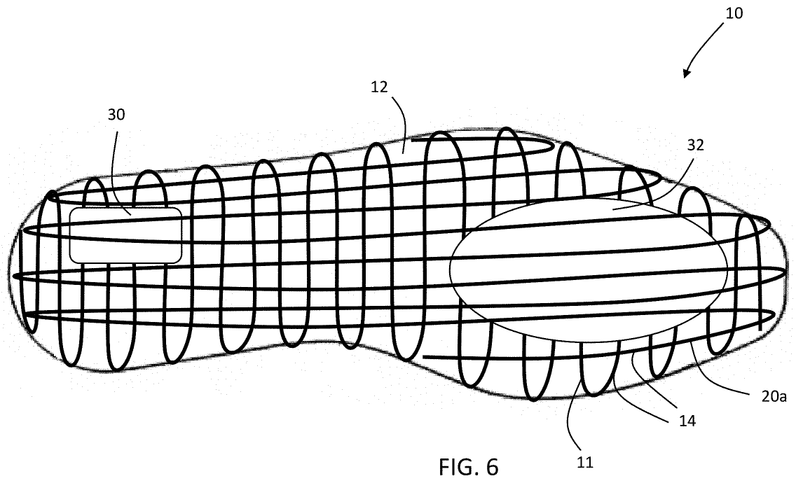

According to embodiments, such as those shown in FIGS. 5 and 6, the inventive perform and shoe sole construction include electronics 30 such as sensors, lights, and/or batteries and or reinforcing elements 32 such as crush and puncture resistant plates embedded in the fiber preform.

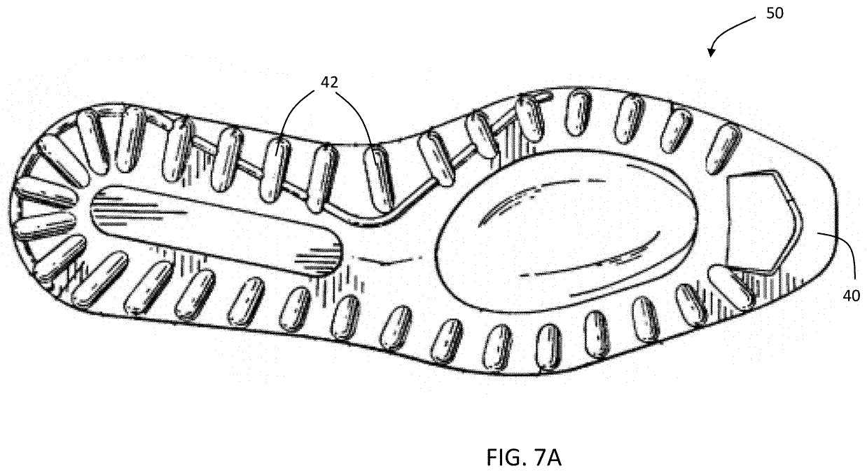

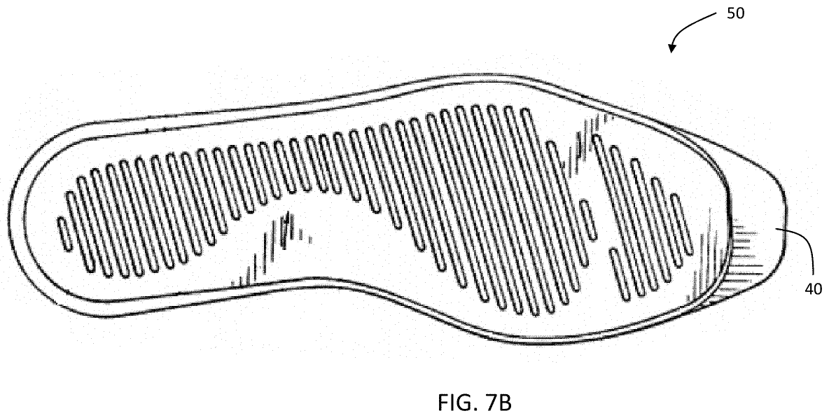

According to embodiments, an inventive fiber preform 10 is molded in a cured resin 40 surrounding the fiber preform. The cured molded resin has a shape that resembles a shoe sole 50, such as that shown in FIGS. 7A and 7B. The offset orientations of the fiber preform provide an orthotropic shoe sole in that there is flexibility in the walking direction, i.e. the toe to heel direction, and there is stiffness in the right to left direction of the shoe sole. According to embodiments, the cured molded resin is a thermoplastic of urethane or a thermoset of urethane, epoxy, vinylester, polyester, caprolactum, or a combination thereof. According to embodiments, the cured molded resin of the shoe sole has a tread 42 on a bottom side of the shoe sole as shown in FIG. 7A. It is appreciated that the epoxy can be a powder that is on the reinforcing powder and cures with heat and pressure; or the epoxy can also be a thermoplastic or a lightly cross-linked cured epoxy fiber which softens and wets out the reinforcing fibers during the molding process. Thermoset powder epoxy coated fiber is detailed in U.S. Pat. No. 7,648,733.

The present invention also provides a shoe including an orthotropic shoe sole 50 as described and a shoe upper that is attached to the composite material shoe sole according to any suitable method.

An inventive method is provided for forming a fiber preform 10 such as the fiber preforms disclosed above. The method includes providing a substrate 12, applying a first layer 11 of a fiber bundle 14 to the substrate 12 in a predetermined pattern having a principal orientation, for example along the X axis. The method continues by stitching the first layer 11 of the fiber bundle 14 to the substrate 12 using a thread. At least one subsequent layer 20a, 20b, 20c, 20d of the fiber bundle 14 is then built-up from the first layer 11 and similarly stitched to a preceding layer using the thread. As described above, the fiber preform 10 produced according to the method of the present disclosure may have subsequent preform layers that are offset from the preceding layer by an angular displacement relative to the principal orientation of the first layer 11. The angular displacement may be anywhere from 0-90 degrees or, for example, may be any one of 15 degrees, 30 degrees, 45 degrees, 60 degrees, 75 degrees, and 90 degrees, or a combination of various angles. The method may also include removing the substrate 12 once the at least one subsequent preform layer has been built-up form the first layer 11.

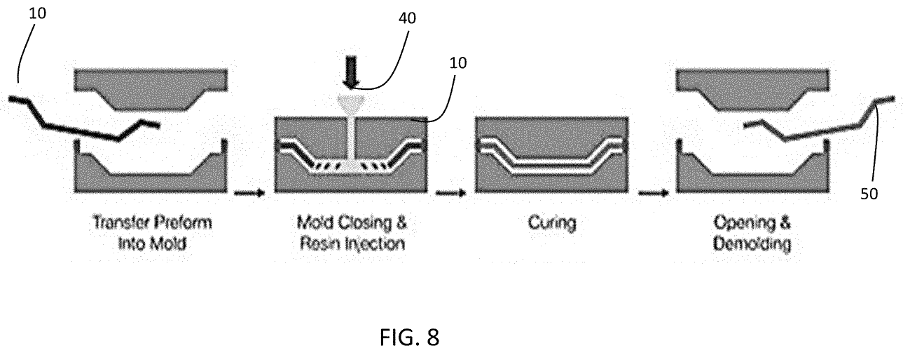

Furthermore, as shown in FIG. 8, the present invention also provides a method for forming an orthotropic composite material shoe sole 50 that includes a fiber preform 10, such as the fiber preforms disclosed above, in a mold cavity having a shape, injecting a curable resin into the mold cavity such that the curable resin surrounds the fiber preform, and curing the curable rein into the shape of the mold.

The foregoing description is illustrative of particular embodiments of the invention but is not meant to be a limitation upon the practice thereof. The following claims, including all equivalents thereof, are intended to define the scope of the invention.

1. A fiber preform comprising:
a substrate; and
a fiber bundle comprising reinforcing fibers arranged on the substrate in a shape of a shoe sole and attached to the substrate by a plurality of stitches of the thermoplastic thread to form a first preform layer having a principal orientation.

2. The fiber preform of claim 1 further comprising at least one subsequent preform layer formed of the fiber bundle and successively stacked from the first preform layer, each subsequent preform layer arranged on a preceding preform layer and attached to the preceding preform layer by additional stitches of the thread.

3. The fiber preform of claim 2 wherein an orientation of each of the subsequent preform layer is offset from that of the preceding preform layer by an angular displacement relative to the principal orientation of the first layer.

4. The fiber preform of claim 3 wherein the angular displacement between each of the preform layers is any one of 15 degrees, 30 degrees, 45 degrees, 60 degrees, 75 degrees, and 90 degrees.

5. The fiber preform of claim 2 wherein the substrate is removable from the fiber preform after the at least one subsequent preform layers are stacked from the first preform layer and each of the subsequent preform layers is attached to the preceding preform layer.

6. The fiber preform of claim 1 wherein the fiber bundle is also attached to itself by the plurality of stitches of the thread.

7. The fiber preform of claim 1 wherein the fiber bundle includes a subset of yarn fibers, a subset of roving fibers, or a combination thereof.

8. The fiber preform of claim 1 wherein the reinforcing fibers of the fiber bundle comprise glass fiber, carbon fiber, Basalt fiber, or a combination thereof.

9. The fiber preform of claim 1 wherein the fiber bundle further comprises thermoplastic fibers of urethane, nylon, polyethylene terephthalate (PET), epoxy, or a combination thereof.

10. The fiber preform of claim 1 wherein the reinforcing fibers of the fiber bundle are present in an amount of 10 to 100 weight percent of the fiber bundle.

11. The fiber preform of claim 1 wherein the fiber preform is formed of a single continuous fiber bundle.

12. The fiber preform of claim 1 wherein the fiber preform is formed of at least two separate fiber bundles.

13. The fiber preform of claim 13 wherein the parameters of the plurality of stitches include a linear distance between the stitches and a tension of the stitches.

14. An orthotropic composite material shoe sole comprising:
a fiber preform of claim 1; and
a cured molded resin surrounding the fiber preform, the cured molded resin having a shape.

15. The orthotropic composite material shoe sole of claim 14 wherein the cured molded resin is a thermoplastic of urethane.

16. The orthotropic composite material shoe sole of claim 14 wherein the cured molded resin is a thermoset of urethane, epoxy, vinylester, polyester, caprolactum, or a combination thereof.

17. The orthotropic composite material shoe sole of claim 14 wherein the cured molded resin has a tread on a bottom surface.

18. A method of forming a fiber preform for use in a composite material shoe sole, the method comprising:
providing a substrate;
applying a first layer of a fiber bundle to the substrate in a predetermined pattern having a principal orientation, the fiber bundle comprising reinforcing fibers;
stitching the first layer of the fiber bundle to the substrate using a thread;
building up at least one subsequent layer of the fiber bundle upon the first layer; and
stitching each of the subsequent layers to a preceding layer using the thread.

19. The method of claim 18 wherein each of the subsequent layers of the fiber bundle is offset from the preceding layer by an angular displacement relative to the principal orientation of the first layer.

20. The method of claim 19 wherein the angular displacement is any one of 15 degrees, 30 degrees, 45 degrees, 60 degrees, 75 degrees, and 90 degrees.
